(19) United States
(12) Patent Application Publication
(10) Pub. No.: US 2018/0333689 A1
(43) Pub. Date: Nov. 22, 2018

(54) AUTOMATED MIXING AND DISPENSING CLEANSER APPARATUS

(71) Applicant: Clarence Lance Richardson, Columbus, OH (US)

(72) Inventor: Clarence Lance Richardson, Columbus, OH (US)

(21) Appl. No.: 15/597,923

(22) Filed: May 17, 2017

(51) Int. Cl. B01F 3/08; B01F 15/00; B01F 15/06; B01F 7/00; B01F 7/04

(52) U.S. Cl. CPC B01F 3/0853; B01F 15/0087; B01F 15/066; B01F 7/00733; B01F 2003/0892; B01F 7/04; B01F 2015/062; B01F 2215/0077; B01F 15/00253

(57) ABSTRACT

An automated soap mixing and dispensing apparatus is configured to automatically melt a quantity of solid soap for mixture with a liquid carrier to provide a source of liquid soap solution. The apparatus includes a fluid reservoir configured to initially contain liquid carrier. A grill with apertures supports the solid soap. A heating element heats the solid soap to a molten state and the molten soap drips through the apertures into the liquid carrier. A rotary mixing unit mixes the molten soap with the liquid carrier to form the liquid soap solution. The dispensing apparatus may then be utilized to dispense the liquid soap for cleaning activities, such as personal hygiene. The apparatus improves the carbon footprint for hygiene activities by eliminating the requirement for plastic containers containing premixed liquid soap solutions.

### BACKGROUND OF THE INVENTION

The present invention relates to soap dispensers and, more particularly, to automatic liquid soap dispensers for hygiene activities.

Conventional automated soap dispensing apparatus generally utilize plastic containment reservoirs to carry the liquid soap. These containment reservoirs are intended to be disposed of and are generally not refillable, leading to an increase in the carbon footprint for organizations with health and hygiene compliance requirements, such as hygiene cleaning solutions (hand/dish soap, detergents).

By eliminating the need to purchase plastic bottles filled with cleaning agents, organizations can reduce yearly aquatic waste, by taking liquid production from manufactures and placing it with the consumers and organizations. Thus leaving manufactures to only produce solid cleaning agents, which can be transported at lower cost than liquid in plastic. Where solids in paper do not require such maintenance for transportation.

By eliminating the need for consumers to purchase plastic bottles of cleanser on such a routine basis. Large corporations will have no excuse to continue to produce the tons of aquatic waste and flood our eco system which such hazardous materials.

### SUMMARY OF THE INVENTION

In one aspect of the present invention is an apparatus for automatically mixing a molten soap with a liquid carrier to provide a liquid soap for dispensing for cleaning activities. The apparatus includes a dispenser housing having a front panel operable between a closed and an open position to provide access to an interior of the dispenser housing. A fluid reservoir having an upper opening is configured to be mounted within the interior of the dispenser housing. By way of non-limiting example, the fluid reservoir may be configured to initially receive approximately (1.5 liters) quantity of a liquid carrier. A grill having a plurality of apertures that are disposed above the upper opening of the fluid reservoir is configured to support a quantity of a solid soap. A heating source is configured to selectively heat and compress the solid soap to a molten state. A rotary mixer is mounted for rotation within an interior volume of the fluid reservoir and is selectively operable to mix the molten soap with the liquid carrier to form a liquid cleanser. A dispenser nozzle is in fluid communication with the interior volume of the fluid reservoir and is configured to selectively dispense the liquid soap.

The apparatus may also include a soap containment tray disposed above the grill to contain the solid soap on the grill. A lid connects to the top of the dispenser housing and be operable between a raised position, providing access to the grill and a lowered position closing off access to the grill. The heating source may alternatively be carried by the lid. A fixed spring may be interposed between an inside surface of the lid and the heating source carried by the lid. The spring is configured to bias the heating source against the solid soap.

A controller is provided to selectively operate the heating source. The controller may activate the rotary mixer when the heating source is operational and may also activate the rotary mixer at a predetermined interval when the heating source is not operational. A sensor may be used to determine that the quantity of the solid soap has been depleted. The controller may then prevent activation of the heating source when the quantity of solid soap has been depleted. The sensor may be a force sensor operatively coupled to the spring. One of a motion sensor or a proximity sensor may be carried on the dispenser nozzle.

In some aspects of the apparatus, an additive application tube may extend upwardly from a top end of the fluid reservoir and is configured to communicate an additive agent to the liquid carrier. The liquid carrier may be selected from the group consisting of water, isopropyl alcohol, and vegetable oils. The additive agent may be selected from a group consisting of a fragrance, a sanitizer, a deodorizers, and an anti-microbial agent.

These and other features, aspects and advantages of the present invention will become better understood with reference to the following drawings, description and claims.

### BRIEF DESCRIPTION OF THE DRAWINGS

FIG. 1 is a perspective view of the invention.

FIG. 2 is a front view of the invention.

FIG. 3 is a front view of the invention with top and front cover open.

FIG. 4 is a top view of the invention with top cover open.

FIG. 5 is a side view of the invention with top and front cover open.

FIG. 6 is a section view of the invention taken along line 6-6 in FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved automated soap mixing and dispensing apparatus is illustrated. The apparatus is configured to melt a bar of solid soap which is then mixed with a volume of a tap water to provide a source of liquid soap for dispensing to clean items, such as a user's hands/body for hygiene purposes.

The automated soap mixing and dispensing apparatus will help reduce the carbon footprint for organizations with health and hygiene compliance requirements. By eliminating the need to purchase plastic bottles filled with cleaning agents. By helping organizations reduce yearly aquatic waste, by taking liquid production from manufactures and placing it with the consumer. Thus leaving only a need to produce solid cleaning agents. That can be transported in paper not plastic.

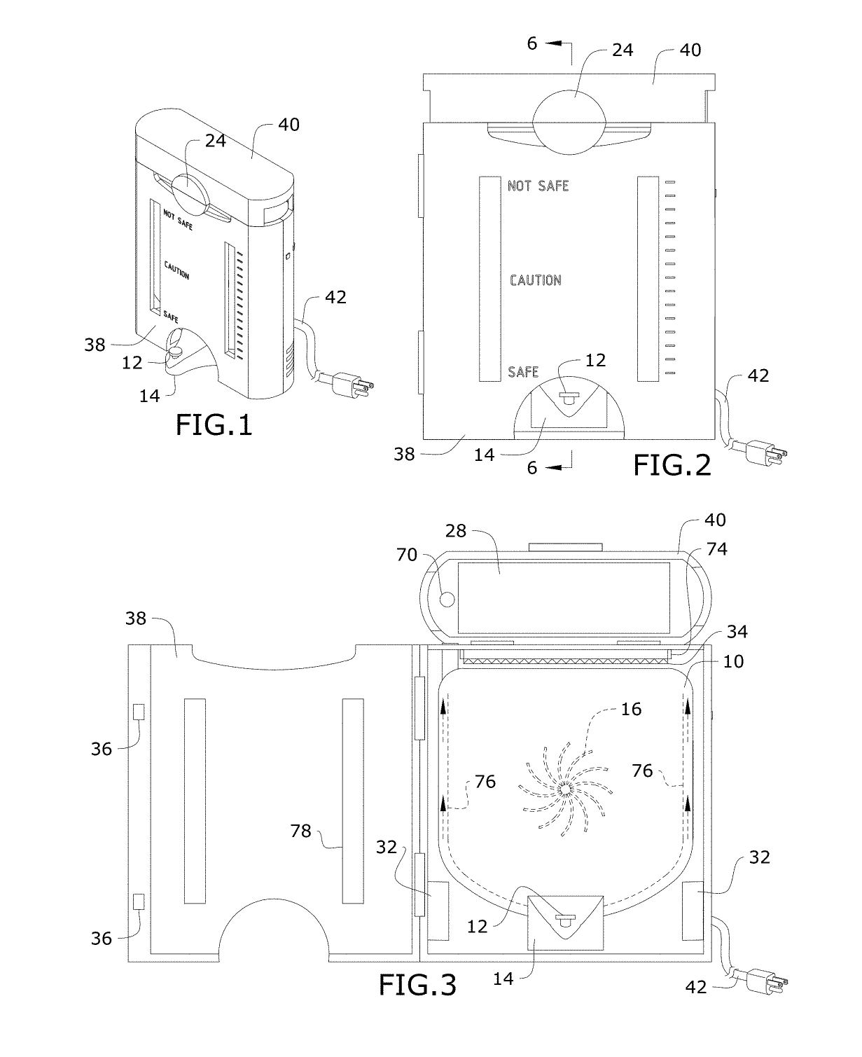

An embodiment of an automated soap mixing and dispensing apparatus is illustrated in reference to FIGS. 1 and 2. The apparatus has a housing that includes a front panel 38 having a slot carrying indicia of a thermal condition of the apparatus. A second slot may provide a visual indication for a fill level. A dispensing stopper 12 and spout 14 extend through an opening in the front panel 38. The dispensing stopper 12 is operable between an open and a closed position to selectively dispense a quantity of liquid soap 22 from the dispensing apparatus.

A lid 40 is provided at a top of the apparatus to allow the user to replenish the solid soap 68 and the volume of liquid 22 as these elements are depleted during use. A latch 24 is operable to secure the lid 40 in a closed position. The lid 24 may also include a light emitting diode (LED) indicator light to provide the user an operational condition of the apparatus: By way of example, the LED indicator light may be an RGB LED that signals RED in an active or heating condition; YELLOW for a cooling condition, and GREEN for a ready condition.

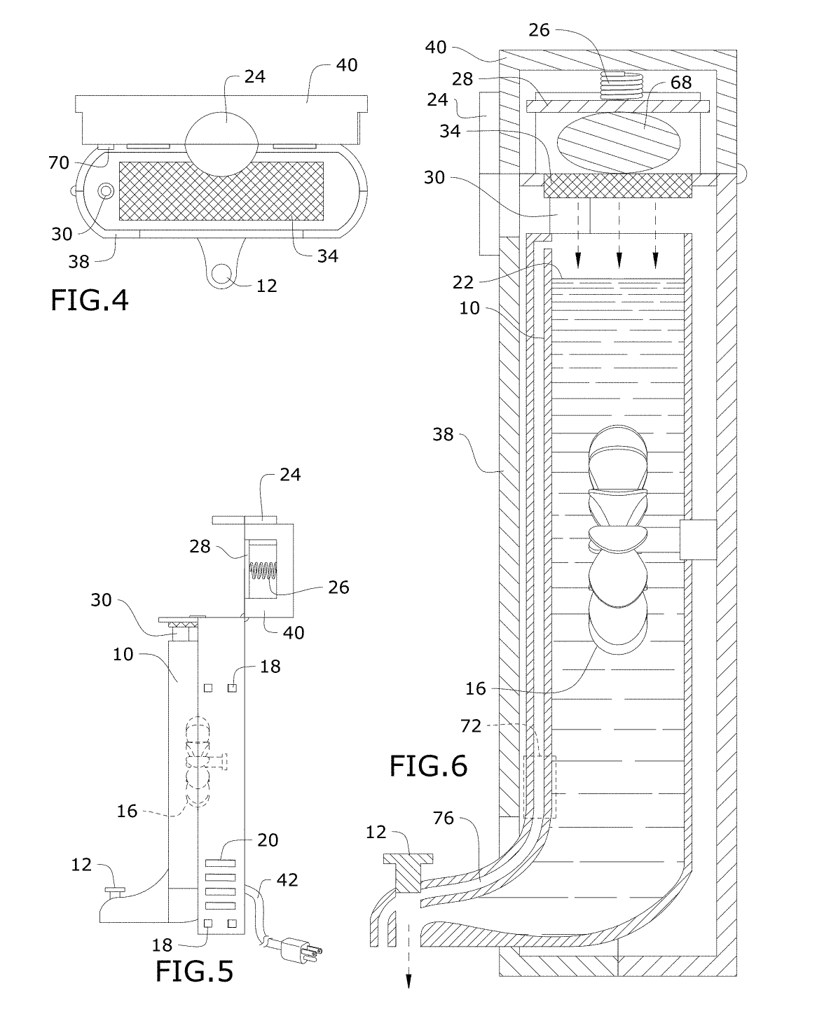

As seen in reference to FIGS. 3-4, the front panel 38 may be opened to access the interior of the housing. The front panel 38 may have one or more latch elements 36 to secure the front panel 38 to a protruding tab 18 located on the housing. A thermometer 78 may be attached to an interior surface of the front panel 38 such that the thermal condition of the apparatus is visible through the first slot.

A fluid reservoir 10 is contained within the housing to initially carry a volume of a liquid carrier. The liquid carrier may be selected from the group consisting of water, isopropyl alcohol, and vegetable oils. The fluid reservoir 10 has an opening at a top end thereof that is positioned subjacent to a grill 34 carried at an upper end of the interior of the housing. A soap containment tray 74 may surround a majority of the grill 34 to retain the soap 68 solids over the grill 34. A heat source 28 may be carried in the lid 40. When activated, the heat source melts a quantity of solid soap 68 supported by the grill 34. The grill 34 includes a plurality of openings such that melted soap may pass through the grill 34 and be received in the fluid reservoir 10.

A rotary mixer 16 is supported within the fluid reservoir 10 and is operable to mix the melted soap with the volume of liquid carrier contained within the fluid reservoir.10. A controller circuit may be configured to ensure operation of the rotary mixer 16 while the heat source 28 is operational or has reached a melting temperature of the soap 68 to ensure that the melted soap is mixed with the liquid carrier so that it is dissolved before the melted soap may solidify. The controller circuit may also be configured to activate the rotary mixer 16 at predetermined intervals to keep the liquid soap in a mixed state with the liquid carrier contained within the fluid reservoir 10. The rotary mixer 16 may continue to mix after the melted soap has been dissolved and may stop once the unit has cooled.

An additive application tube 30 may be provided that extends from a top end of the housing interior and extends into the liquid reservoir 10. The additive application tube 30 may be utilized to add a quantity of fragrances, scented liquids, sanitizers, deodorizers, or anti-microbial agents for mixture in the fluid reservoir 10 to give the mixed liquid soap 22 a pleasing scent or other desired properties based on the agents added to the mixture. A corresponding fragrance application tube stopper 70 is applied to assist with keeping the air pressure static so that it properly exits via the air vents, as well to negate any potential solution to seep up through the fragrance applicator.

One or more air filters 32 are provided through a side wall of the housing to provide ventilation of the housing during heating and mixing cycles to provide a substantially contaminant free source of air within the apparatus. When combined with fragrances, the apparatus may emit an air freshening scent in proximity of the apparatus. The air filters 32 may also have a louver, or flap 20, to selectively open and close airflow through the air filter 32. The controller may be programmed to open the louvers 20 to open when the heating source 28 and/or the rotary mixer 28.

The dispensing spout 14 is positioned at a bottom end of the fluid reservoir 10 so that the liquid soap 22 mixture may be dispensed. One or more vapor lock channels 76 may be carried within the fluid reservoir 10 and extend between the dispensing spout 14 and the top opening of the fluid reservoir 10 to prevent a hydraulic locking condition and permit the liquid soap 22 to be dispensed through the dispensing spot 14. The vapor lock channels 76 may be formed as a cavity defined in the fluid reservoir 10 or may be formed by tubes carried in the fluid reservoir 10. A flow regulator 72 may be provided to control the quantity of airflow through the vapor lock channels 76 to ensure a steady stream of delivered liquid soap from the spout 14.

As seen in the side sectional view of FIG. 5, the heating source 28 is biased downwardly by a spring 26 so that the heat source 28 may be pressed against the solid soap 68 when it is supported on the grill 34 and contained within the soap containment tray 74. One or more sensors may be provided to alert the operator that the solid soap 68 has been depleted and to prevent the activation of the heat source 28 when solid soap 68 is not present for melting. The sensors may include a weight sensor coupled to the grill 34 and containment tray 74. Alternatively, the sensor may include a force transducer that determines the force applied by the biasing spring 26 to detect when a biasing force is no longer being applied due to the depletion of the solid soap 68. A biasing force sensor would also automatically interrupt power to the heating source 34 when the lid 40 is in an open position.

The dispensing stopper 12 may be configured as a simple mechanical valve to permit the flow of liquid soap 22 through the dispensing spout 14 and vapor lock channels 76. The dispensing stopper 12 may also be configured as an electro-mechanical valve to control flow of the dispensed liquid soap 22, control the louvers 20, or other functions of the apparatus.

It should be understood, of course, that the foregoing relates to exemplary embodiments of the invention and that modifications may be made without departing from the spirit and scope of the invention as set forth in the following claims.

What is claimed is:

1. An apparatus for automatically mixing a molten soap with a liquid carrier to provide a liquid cleanser for dispensing, comprising:
a dispenser housing having a front panel operable between a closed and an open position to provide access to an interior of the dispenser housing;
a fluid reservoir having an upper opening configured to be mounted within the interior of the dispenser housing, the fluid reservoir configured to receive a predetermined quantity of a liquid carrier;
a grill having a plurality of apertures that are disposed above the upper opening of the fluid reservoir, the grill configured to support a quantity of a solid soap in its greater center;
a heating source configured to selectively heat the solid soap to a molten state;
a rotary mixer mounted within an interior volume of the fluid reservoir and selectively operable to mix the molten soap with the liquid carrier to form a liquid soap;
a dispenser nozzle in fluid communication with the interior volume of the fluid reservoir and configured to selectively dispense the liquid soap.

2. The apparatus of claim 1, further comprising:
a soap containment tray disposed above the grill to contain the solid soap on the grill.

3. The apparatus of claim 1, wherein the grill comprises the heating source.

4. The apparatus of claim 1, further comprising:
a lid connected to a top of the dispenser housing and operable between a raised position, providing access to the grill and a lowered position closing off access to the grill.

5. The apparatus of claim 4, wherein the heating source is carried by the lid.

6. The apparatus of claim 5, further comprising:
a spring interposed between an inside surface of the lid and the heating source carried by the lid, wherein the spring is configured to bias the heating source against the solid soap.

7. The apparatus of claim 6, further comprising:
a controller to selectively operate the heating source.

8. The apparatus of claim 7, wherein the controller operates the heating source for a predetermined period of time.

9. The apparatus of claim 7, wherein the controller activates the rotary mixer when the heating source is operational.

10. The apparatus of claim 9, wherein the controller activates the rotary mixer at a predetermined interval when the heating source is not operational.

11. The apparatus of claim 10, further comprising:
a sensor to determine that the quantity of the solid soap has been depleted.

12. The apparatus of claim 11, wherein the controller prevents activation of the heating source when the quantity of solid soap has been depleted.

13. The apparatus of claim 11, wherein the sensor comprises:
a force sensor operatively coupled to the spring.

14. The apparatus of claim 1 further comprising:
one of a motion sensor or a proximity sensor carried on the dispenser nozzle.

15. The apparatus of claim 1, further comprising:
an additive application tube that extends upwardly from a top end of the fluid reservoir configured to communicate an additive agent to the liquid carrier.

16. The apparatus of claim 15, wherein the liquid carrier is selected from the group consisting of water, isopropyl alcohol, and vegetable oils.

17. The apparatus of claim 16, wherein the additive agent is selected from a group consisting of a fragrance, a sanitizer, a deodorizers, and an anti-microbial agents.
